(19) United States
(12) Patent Application Publication
(10) Pub. No.: US 2008/0246572 A1
(43) Pub. Date: Oct. 9, 2008

(54) Magnet Roller

(75) Inventor: Masaharu Iwai, Tochigi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: KANEKA CORPORATION, Osaka-shi, Osaka (JP); TOCHIGI KANEKA CORPORATION, Mooka-shi, Tochigi (JP)

(21) Appl. No.: 11/569,997

(22) PCT Filed: May 23, 2005
(86) PCT No.: PCT/JP2005/009321

§ 371 Date: Jan. 11, 2008

(30) Foreign Application Priority Data
Jun. 4, 2004 (JP) 2004-167000

(51) Int. Cl. H01F 7/02

(52) U.S. Cl. 335/302

(57) ABSTRACT

In a magnet roller of the magnet piece bonding type, the main pole has a high magnetic flux density and the other pole has an asymmetric magnetic flux density pattern with respect to the magnetic flux density peak position. The magnet piece of the main pole is formed by injection molding while performing pole-anisotropic orientation of magnetic particles of the magnet piece. The magnet piece of the other pole is formed by extrusion molding while orientating the magnetic particles in a certain direction inclined by 5 degrees of more with respect to the center line of the radial direction of the magnet piece. The magnet roller is formed by combining the magnet piece of the main pole and the magnet piece of the other pole.

### TECHNICAL FIELD

The present invention relates to magnet rollers incorporated in, for example, image forming devices such as copiers, printers and facsimiles.

### BACKGROUND ART

The magnet rollers incorporated in the image forming devices using powder toner in the copiers, the printers and the facsimiles or the like are generally configured as follows.

That is,

(1) a plurality of magnet pieces obtained by orientating a magnetization easy axis in a specific direction simultaneously with extrusion molding are fixed to a shaft to form a magnet roller (Patent Reference 1).

(2) After a magnet piece having a sectoral section shape and magnetized by orientating the magnetization easy axis of ferrite powder to the other three sides from a center part of a circular arc is injection molded, a plurality of magnet pieces are bonded on a shaft to form a magnet roller (Patent Reference 2).

### Patent Reference 1: Japanese Unexamined Patent Publication No. 59-143171

### Patent Reference 2: Japanese Unexamined Patent Publication No. 62-282423

### DISCLOSURE OF THE INVENTION

### Technical Problems to be Solved

However, as shown in the Patent Reference 1, the magnetic particles of each of the magnet pieces corresponding to magnetic pole positions are orientated in a parallel direction with respect to the center line of the radial direction. The magnetic particles of the magnet piece between the magnetic poles are orientated in a perpendicular direction with the respect to the center line of the radial direction (The center line of the radial direction is a line extended to the circumferential direction from the center point of the magnet roller, and the line passes a point for equally dividing the circular arc of the outer circumference of the magnet piece into two). That is, the orientation direction of the magnetic particles of the magnet piece is orientated parallel to the center line of the radial direction, or perpendicular to the center line of the radial direction (That is, the magnetic particles are orientated parallel to the perpendicular direction of a bonded surface when viewed from the bonded surface with adjoining magnet piece). Since the orientation of the magnetic particles is not inclined with respect to the above parallel line and perpendicular line, only a simple magnetic flux density pattern may be able to be formed, which is not shown in the Patent reference 1. Also, in the patent, eight magnet pieces are used in order to obtain four magnetic poles, and the use of the eight magnet pieces may become costly expensive.

Also, as shown in Patent Reference 2, after the magnet piece having the sectoral section shape and magnetized by orientating the magnetization easy axis of ferrite powder to the other three sides from the center part of the circular arc is injection molded, the plurality of magnet pieces are bonded on the shaft to form the magnet roller. Therefore, it is difficult to form the complicated magnetic flux density pattern, and only the simple magnetic flux density pattern may be able to be formed, which is not shown in the Patent reference 2.

### Means to Solve the Problems

A magnet roller of the present invention is obtained by combining a magnet piece formed by injection molding while performing pole-anisotropic orientation of magnetic particles and a magnet piece formed by extrusion molding while orientating magnetic particles in a certain direction inclined by 5 degrees or more with respect to a center line of a radial direction of the magnet piece. Thereby, the degree of freedom of a magnetic flux density pattern of each of the magnet pieces can be enhanced, and a complicated magnetic flux density pattern can be formed.

In the magnet roller of the present invention, an ethylene ethyl acrylate resin is used as a binder resin for the magnet piece formed by the extrusion molding, thereby providing the magnet piece having excellent dimension accuracy and moderate flexibility without having fear of warpage. Also, the magnet piece has enhanced degree of freedom of the magnetic flux density pattern, and can form a complicated magnetic flux density pattern.

In the magnet roller of the present invention, a polyamide resin is used as a binder resin of the magnet piece formed by the injection molding, thereby providing the magnet piece having excellent dimension accuracy. Also, the magnet piece has enhanced magnetic flux density strength and can form a magnetic pole having a high magnetic flux density.

In the magnet roller of the present invention, an ethylene ethyl acrylate resin is used as a binder resin of the magnet piece formed by the injection molding, thereby providing the magnet piece having excellent dimension accuracy and moderate flexibility without having fear of warpage. Also, the magnet piece has enhanced magnetic flux density strength and can form a magnetic pole having a high magnetic flux density

### EFFECT OF THE INVENTION

According to the present invention (claim 1), the magnet piece formed by the injection molding has the high magnetic flux density, and each of the magnet pieces formed by the extrusion molding has the enhanced degree of freedom of the magnetic flux density pattern. The magnet roller obtained by combining and bonding the magnet piece formed by the injection molding and the magnet pieces formed by the extrusion molding can correspond to the complicated magnetic flux density pattern.

According to the present invention (claim 2), the magnet piece formed by the extrusion molding has the excellent dimension accuracy, and even when the magnet pieces are bonded, the magnet piece has excellent accuracy of a magnetic pole position. Also, the magnet piece has enhanced and stabilized adhesive strength.

According to the present invention (claim 3), the magnet piece formed by the injection molding has the high magnetic flux density and excellent developer fogging.

According to the present invention (claim 4), the magnet piece formed by the injection molding has the high magnetic flux density, moderate flexibility without having fear of warpage. Also, the magnet piece has enhanced and stabilized adhesive strength.

### BRIEF DESCRIPTION OF THE DRAWINGS

FIG. 1 shows bonded magnet pieces and magnetic flux density patterns of the present invention.

FIG. 2 shows a magnetic circuit part of a mold for injection molding of a magnet piece.

FIG. 3 shows a magnetic circuit part of a mold for extrusion molding of a magnet piece.

FIG. 4 shows a magnetic circuit part of a mold for extrusion molding of a magnet piece.

FIG. 5 shows a magnetic circuit part of a mold for injection molding of a magnet piece.

FIG. 6 shows a magnetic circuit part of a mold for extrusion molding of a magnet piece.

FIG. 7 is a perspective view of a magnet roller of the present invention.

FIG. 8 shows a half-length width of 80% and a half-length width of 50% in a magnetic flux density pattern.

### DESCRIPTION OF THE SYMBOLS

1: Magnet piece
2: Magnet piece
3: Magnet piece
4: Shaft
5: Orientation magnetizing direction of magnetic particles
6: Magnetic flux density pattern
7: Sleeve
8: Magnetic flux density peak position (magnetic pole position)
9: Center line of radial direction of magnet piece
10: Electromagnet
11: Orientation magnetizing yoke (magnetic body)
12: Magnetic body
13: Center point of magnet roller
14: Line connecting center point of magnet roller to magnetic flux density peak position
15: Magnet roller main body (magnet piece bonded part)

### BEST MODE FOR CARRYING OUT THE INVENTION

A magnet roller of the present invention is configured by combining a magnet piece formed by injection molding while performing pole-anisotropic orientation of magnetic particles and a magnet piece formed by extrusion molding while orientating magnetic particles in a certain direction inclined by 5 degrees or more with respect to a center line of a radial direction of the magnet piece.

As shown in the Patent Reference 1, the conventional magnet roller is obtained by bonding a plurality of magnet pieces formed by the extrusion molding on the periphery of a shaft. The orientation direction of the magnetic particles of the magnet piece is parallel to the center line of the radial direction. The magnet piece between the magnetic poles is orientated in a direction perpendicular to the center line of the radial direction.

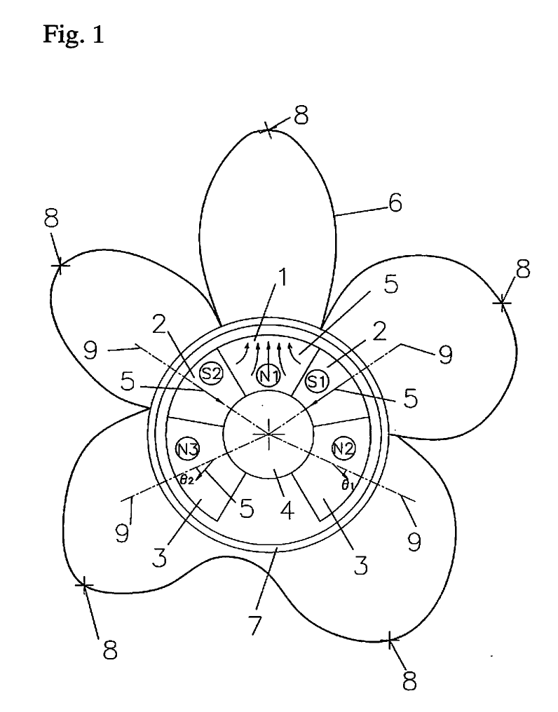

In the present invention, for example, as shown in FIG. 1, the high magnetic flux density is obtained by orientating the magnetic particles of the magnet piece of an N1 pole (hereinafter, referred to as pole-anisotropic orientation) so that the magnetic particles are converged from the side face and the bottom face to a part of the outer circumferential face. Also, in an N2 pole and an N3 pole, the magnetic flux density patterns of the N2 pole and N3 pole which are an asymmetric pattern (a complicated pattern can be formed) with respect to the magnetic flux density peak position are obtained by inclining the magnetic particles by θ1 and θ2 with respect to the center line 9 of the radial direction of the magnet piece (θ1=20 degrees=5 degrees (θ1 is preferably 5 degrees or more, for example, θ1=20 degrees) and (θ2=25 degrees=5 degrees (θ2 is preferably 5 degrees or more, for example, θ2=25 degrees).

Herein, when the θ1 and the θ2 are less than 5 degrees, the θ1 and the θ2 are almost the same as 0 degree, and an effect of the inclination of the magnetic particles is not exhibited. Also, when the θ1 and the θ2 exceed 90 degrees, the polarity is turned into reverse polarity (for example, an N pole is turned into an S pole), and the target magnetic flux density pattern is not obtained.

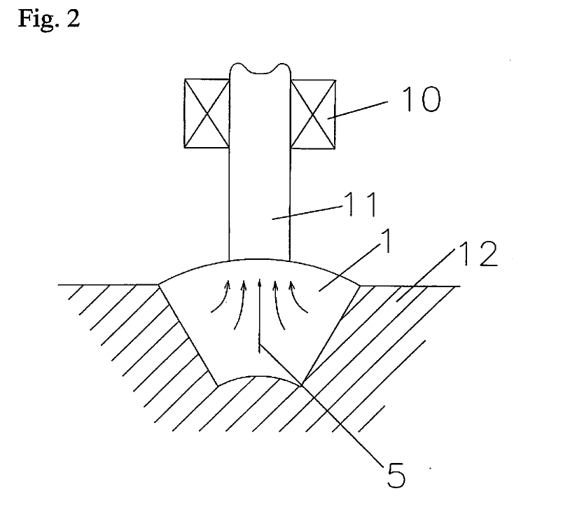

The magnet piece 1 of the N1 pole is obtained by the following method using a mold having a magnetic circuit as shown in FIG. 2. A melted resin magnetic material is injected from an inlet while applying a magnetic field of 240 K-A/m to 2400 K-A/m using an orientation magnetizing yoke 11 arranged in the mold and having an electromagnet or a permanent magnet. The magnetic particles are subjected to orientation magnetization in a desired direction, and cured to obtain the magnet piece of the N1 pole. Since the obtained magnet piece is formed in the mold by injection molding, the magnet piece has more excellent dimension accuracy than that of an extrusion-molded article. Thereby, post processing such as outer circumference cutting for uniforming the size of the outer circumference of the magnet and highly precise cutting of the length direction or the like after bonding the magnet pieces on the shaft becomes unnecessary to obtain the magnet piece having high dimension accuracy at low cost. Also, since the melted viscosity of the melted resin magnet in the injection molding is far lower than that of the extrusion molding or the like, the orientation degree of the magnetic particles is enhanced to obtain the magnet piece having high magnetic property.

The above magnet piece mainly contains a mixture of 50% by weight to 95% by weight of an anisotropic ferrite magnetic powder and 5% by weight to 50% by weight of a resin binder. If needed, silane and titanate coupling agents as a finishing agent, a polystyrene and fluoride lubricating agents for enhancing flow property, a stabilizer, a plasticizer or a fire retardant or the like are added, and are dispersively mixed. The resultant mixture is melted and kneaded, and molded into pellets before injection molding.

The orientation magnetization magnetic field applied in the formation needs only to be suitably selected according to magnetic flux density specification required for each of the magnetic poles. Also, the orientation magnetization magnetic field may not be applied in the formation but be subjected to magnetization after the formation depending on the required magnetic property.

Herein, Examples of the magnetic powders include an anisotropic ferrite magnetic powder having a chemical formula represented by MO-nFe₂O₃ wherein n is a natural number. In the formula, one or more of Sr, Ba and Pb are suitably used as the “M”. Also, examples of the resin binders include thermoplastic resins such as vinyl chloride-vinyl acetate copolymer, ethylene-ethyl acrylate resin, polyamide resin, polystyrene resin, polyethylene terephthalate (PET), polybutylene terephthalate (PBT), polyphenylene sulfide (PPS), ethylene-vinyl acetate copolymer (EVA), ethylene-vinyl alcohol copolymer (EVOH), chlorinated polyethylene (CPE) and polyvinyl chloride (PVC), and thermosetting resins such as epoxy resin, phenol resin, urea resin, unsaturated polyester resin, melamine resin, furan resin and polyimide resin. These may be used alone or combination thereof.

Also, an anisotropic ferrite magnetic powder, an isotropic ferrite magnetic powder, an anisotropic rare earth magnetic powder (for example, SmFeN) and an isotropic rare earth magnetic powder (for example, NeFeB) may be used alone or combination thereof as the magnetic powder according to the required magnetic flux density. If the content of the single magnetic powder or mixed magnetic powder described above is less than 50% by weight, the insufficiency of magnetic powder may cause the magnetic properties of the magnet piece to be impaired so that a desired magnetic force is not obtained, and if the content is more than 95% by weight, insufficiency of binder may cause the molding properties of the magnet pieces to be impaired.

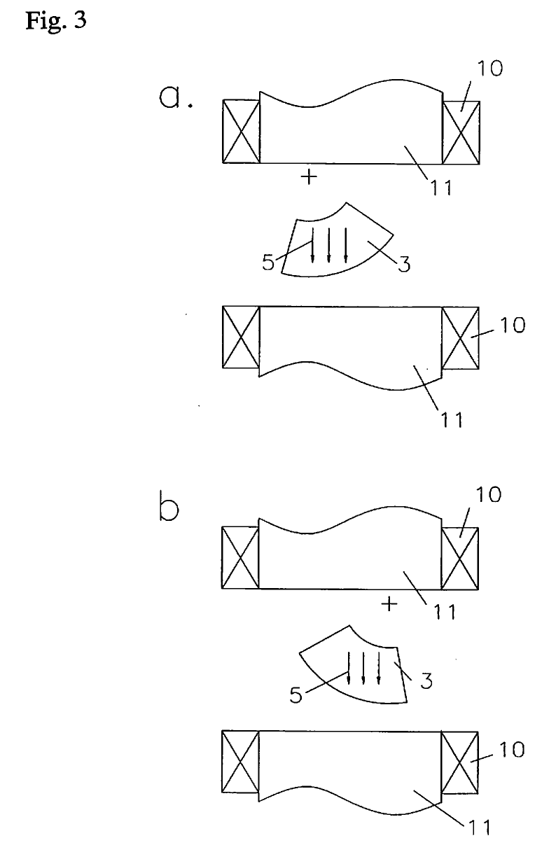

Also, in the present invention, the magnet pieces of the N2 pole and N3 pole are obtained by the following method using an extrusion mold (die) having a magnetic circuit as shown in a, b of FIG. 3. The magnetic particles are subjected to orientation magnetization simultaneously with extrusion molding while applying a magnetic field of 240 K-A/m to 2400 K-A/m using an orientation magnetizing yoke arranged in the mold and having an electromagnet or a permanent magnet to obtain the magnet pieces of the N2 pole and N3 pole shown in FIG. 1.

Although the extrusion molding orientates the magnetic particles of the melted resin magnet passing through the inside of the mold by applying an unidirectional magnetic field (in a certain direction) using a mold (die) as shown in FIG. 3, as shown in FIG. 3, as a result, the orientation magnetizing direction of the magnetic particles of the magnet piece can be easily inclined by inclining the opening shape (the section shape of the magnet piece) of the mold. Also, the mold is also very inexpensive as compared with the mold for injection molding, and the mold is also easily adjusted. It may become difficult to incline the orientation magnetizing direction of the magnetic particles of the magnet piece in the injection molding, and an undercut part may be occurred by inclining the magnet piece, thereby becoming difficult to remove the magnet piece. Also, when the undercut part of the magnet piece is formed in a cut-off shape in order to enhance the removal property, the undercut part may have an adverse effect on the magnetic property, thereby causing the reduction of the strength of the magnetic flux density, the deformation of the magnetic flux density pattern and no provision of a desired magnetic flux density strength and pattern. The above magnet piece of the extrusion-molded article has moderate flexibility without having fear of warpage as compared with the magnet piece of the injection-molded article, and is easily bonded onto the shaft. The above magnet piece mainly contains a mixture of 50% by weight to 95% by weight of an anisotropic ferrite magnetic powder and 5% by weight to 50% by weight of a resin binder. If needed, silane and titanate coupling agents as a finishing agent, a polystyrene and fluoride lubricating agents for enhancing flow property, a stabilizer, a plasticizer or a fire retardant or the like are added, and are dispersively mixed. The resultant mixture is melted and kneaded, and molded into pellets before extrusion molded. The orientation magnetization magnetic field applied in the formation needs only to be suitably selected according to magnetic flux density specification required for each of the magnetic poles. Also, the orientation magnetization magnetic field may not be applied in the formation but be subjected to magnetization after the formation depending on the required magnetic property.

Herein, Examples of the magnetic powders include an anisotropic ferrite magnetic powder having a chemical formula represented by MO.nFe₂O₃ wherein n is a natural number. In the formula, one or more of Sr, Ba and Pb are suitably used as the “M”.

Also, examples of the resin binders include thermoplastic resins such as vinyl chloride-vinyl acetate copolymer, ethylene-ethyl acrylate resin, polyamide resin, polystyrene resin, polyethylene terephthalate (PET), polybutylene terephthalate (PBT), polyphenylene sulfide (PPS), ethylene-vinyl acetate copolymer (EVA), ethylene-vinyl alcohol copolymer (EVOH), chlorinated polyethylene (CPE) and polyvinyl chloride (PVC), and thermosetting resins such as epoxy resin, phenol resin, urea resin, unsaturated polyester resin, melamine resin, furan resin and polyimide resin. These may be used alone or combination thereof. Also, an anisotropic ferrite magnetic powder, an isotropic ferrite magnetic powder, an anisotropic rare earth magnetic powder (for example, SmFeN) and an isotropic rare earth magnetic powder (for example, NeFeB) may be used alone or combination thereof as the magnetic powder according to the required magnetic flux density. If the content of the single magnetic powder or mixed magnetic powder described above is less than 50% by weight, the insufficiency of magnetic powder may cause the magnetic properties of the magnet piece to be impaired so that a desired magnetic force is not obtained, and if the content is more than 95% by weight, insufficiency of binder may cause the molding properties of the magnet pieces to be impaired.

Since the orientation magnetizing direction of the magnetic particles of the S1 pole and S2 pole of FIG. 1 is parallel to the center line of the radial direction of the magnet piece, the molding method could be of either the extrusion molding or the injection molding. Herein, the extrusion molding method will be described.

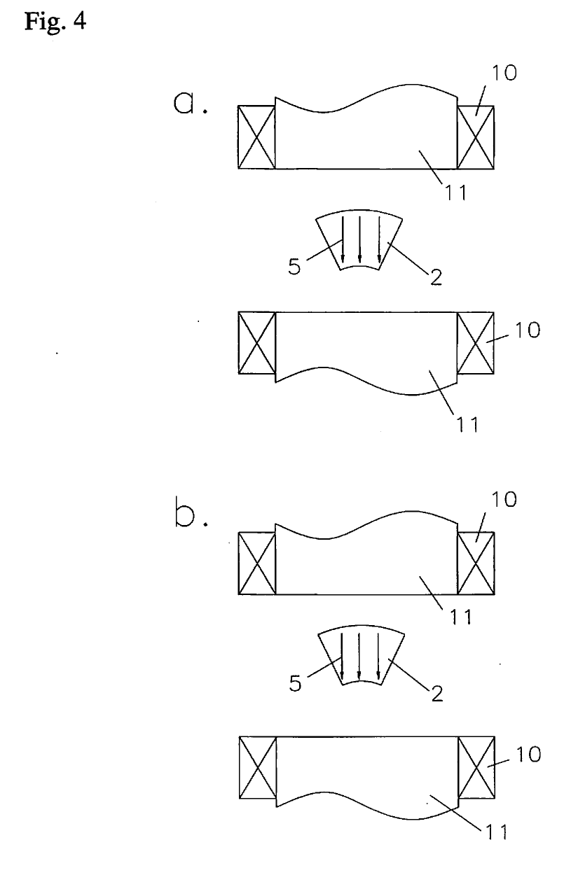

An extrusion mold (die) having a magnetic circuit as shown in a, b of FIG. 4 is used. The magnetic particles are subjected to orientation magnetization simultaneously with extrusion molding while applying a magnetic field of 240 K-A/m to 2400 K-A/m using an orientation magnetizing yoke arranged in the mold and having an electromagnet or a permanent magnet to obtain the magnet pieces of the S1 pole and S2 pole shown in FIG. 1.

Although the extrusion molding orientates the magnetic particles of the melted resin magnet passing through the inside of the mold by applying an unidirectional magnetic field (in a certain direction) using a mold (die) as shown in FIG. 4, the magnetic field is applied so as to be parallel to the center line of the radial direction of the magnet piece, and the magnetic particles of the magnet piece is subjected to orientation magnetization, as shown in FIG. 4. Also, the mold is also very inexpensive as compared with the mold for injection molding, and the mold is also easily adjusted.

The above magnet piece of the extrusion-molded article has moderate flexibility without having fear of warpage as compared with the magnet piece as the injection-molded article, and is easily bonded onto the shaft. The blend prescription of the material of the magnet pieces of the S1 pole and S2 pole is completely the same as the N2 pole and N3 pole of the extrusion-molded article.

The N1 pole having high magnetic force of 105 mT is attained by bonding each of the magnet pieces obtained by the above forming process on the outer circumferential face of the shaft as shown in FIG. 1. The N2 pole and the N3 pole have an asymmetric magnetic flux density pattern with respect to the magnetic flux density peak position, and thereby the carrying property of a developer, the passing performance of a developer regulation blade, and the peel property of the developer or the like may be enhanced to obtain the excellent image quality. Also, the dimension accuracy of the extrusion-molded article is enhanced by using the ethylene ethyl acrylate resin as the binder resin of the resin magnetic material of the extrusion molding magnet piece. The extrusion-molded article is softer than the injection-molded article of a nylon resin magnet, is harder than the extrusion-molded article of a flexible vinyl chloride resin magnet, has semihard hardness, and has excellent shortness, viscosity and elasticity. The magnetic properties are enhanced and the dimension accuracy of the injection-molded article is enhanced by using the polyamide resin for the binder resin of the resin magnetic material of the injection molding magnet piece. Also, the magnet piece has hard hardness, and thereby the distortion of the axial direction of the magnet piece in bonding the magnet piece on the shaft is decreased. Also, the fogging of the developer may be able to be decreased and prevented by obtaining the high magnetic flux density.

Furthermore, the magnetic properties are enhanced and the dimension accuracy of the injection-molded article is enhanced by using the ethylene ethyl acrylate resin for the binder resin of the resin magnetic material of the injection molding magnet piece. Also, the magnet piece has semihard hardness, and the injection-molded article is easily bonded onto the shaft without having fear of warpage. The fogging of the developer may be able to be decreased and prevented by obtaining the high magnetic flux density. Since it is unnecessary that all the magnet pieces used for the present invention are made of the same material (a binder and a magnetic powder or the like), any combination of the magnet pieces of different kind, the integration of magnetic properties and the reduction of cost may be attained.

Also, herein, although the constitution of the magnet roller of five poles is illustrated, the present invention is not limited to only the magnet roller of five poles. That is, the quantity of the magnet pieces needs only to be selected by a desired magnetic flux density and magnetic field distribution, and the number of the magnetic poles and magnetic pole positions need only to be also set suitably. Furthermore, when the magnetic field is applied simultaneously with the formation, the magnet piece may be once demagnetized in the mold or outside of the mold after the formation, and may be then magnetized for the enhancement in the formwork removal property of a molded product, the adhesion prevention of garbage such as residue of the molded product, and easy handling property of the magnet piece.

### EXAMPLES

The present invention will be specifically described by means of the following Examples and Comparative Examples. It is to be understood that the present invention is not limited to the Examples.

### Example 1

Referring to a magnet piece material for an N1 pole of FIG. 1, there were used 10% by weight (containing a lubricating agent, a plasticizer and a stabilizer) of nylon 6 (P1010, manufactured by Ube Industries, Ltd.) as a resin binder, and 90% by weight of an anisotropic strontium ferrite magnetic powder (SrO.6Fe₂O₃) as a magnetic powder. These were mixed, melted and kneaded and molded into pellets. The pellet was melted to a melted state. A melted resin magnetic material was injected from an inlet by using the mold of FIG. 2. The magnetic particles of the melted resin magnet were pole-anisotropically subjected to orientation magnetization while applying a magnetic field of 1200 K-A/m, and the N1 pole of the magnet piece shown in FIG. 1 was injection-molded.

Referring to a magnet piece material for poles (S1 pole, N2 pole, N3 pole and S2 pole) other than the N1 pole of FIG. 1, there were used 10% by weight (containing a lubricating agent, a plasticizer and a stabilizer) of chlorinated polyethylene (Ebaslen 410P, manufactured by Showa Denko K.K.), and vinyl chloride-vinyl acetate copolymer (MB1008, manufactured by Kanegafuchi Chemical Ind. Co., Ltd.) as the resin binder, and 90% by weight of an anisotropic strontium ferrite magnetic powder (SrO.6Fe₂O₃) as the magnetic powder. These were mixed, melted and kneaded and molded into pellets. The pellet was melted to a melted state. The magnetic particles of the melted resin magnet were unidirectionally subjected to orientation magnetization per each of the pieces while applying a magnetic field of 240 K-A/m to 2400 K-A/m using molds (dies) of a, b of FIG. 3 and a, b of FIG. 4, and each of the pieces was extrusion molded. Particularly, the orientation magnetizing directions of the N2 pole and N3 pole are respectively inclined by 20 degrees and 25 degrees with respect to the center line of the radial direction of the magnet piece.

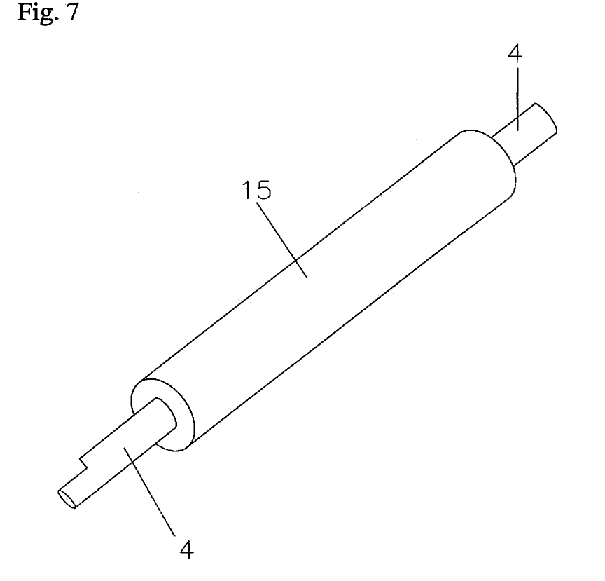

Five poles of the magnet pieces formed as described above were bonded on the outer circumferential face of the shaft to obtain a magnet roller as shown in FIG. 7. The outer diameter of the magnet roller main body, the length of the magnet main body and the outer diameter of the shaft were respectively set to f13.6, 320 mm and f6 (quality of the material: SUM22). A probe (magnetic flux density sensor) was arranged at a position (on a sleeve) 8 mm distant from the center of the magnet roller while supporting both end shaft parts of the obtained magnet roller and rotating the magnet roller. The magnetic flux density pattern of the circumferential direction of the magnet roller was measured using a gauss-meter.

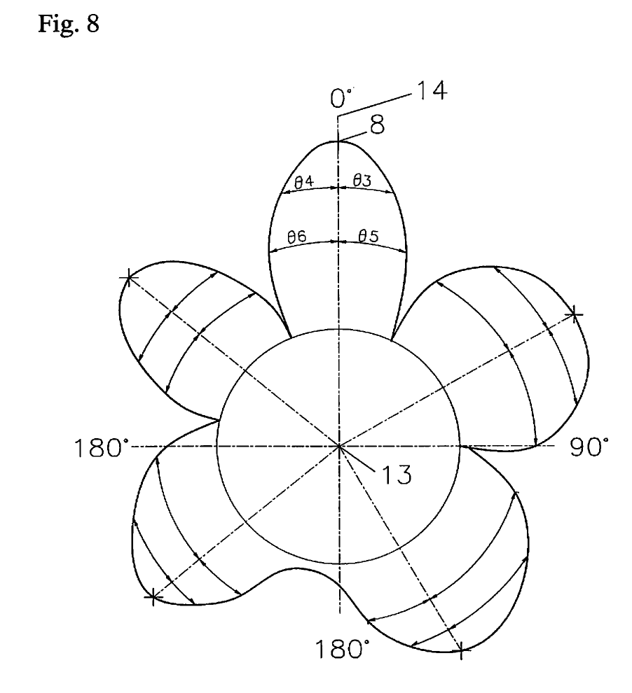

The results of the measurement are shown in Tables 1 to 3. Herein, as shown in FIG. 8, half-length width of 80% of Table 1 means 93 (half-length width of 80% of an S1 side) and θ4 (half-length width of 80% of an S2 side) distributed by an intersecting point of a line 14 connecting the center 13 of the magnet roller to the magnetic flux density peak position and a line (θ3+θ4) connecting positions where the magnetic flux density peak value is 80%. Similarly, half-length width of 50% means 95 (half-length width of 50% of an S1 side) and θ6 (half-length width of 50% of an S2 side) distributed by an intersecting point of a line 14 connecting the center 13 of the magnet roller to the magnetic flux density peak position and a line (θ5+θ6) connecting positions where the magnetic flux density peak value is 50%. The other poles are also the same. Also, the obtained magnet piece was placed on a surface plate, and a pick tester was scanned in the axial direction of the magnet piece. The difference of the maximum and minimum was defined as the warpage amount. Furthermore, the appearance of the magnet piece was visually observed, and the existence of the crack was inspected. The results of the measurement are shown in Table 4.

### Example 2

Referring to a magnet material for extrusion molding (S1 pole, N2 pole, N3 pole and S2 pole), there used 10% by weight (containing a lubricating agent and a stabilizer) of ethylene-ethyl acrylate (PES-210, manufactured by Nippon Unicar Company Limited) as a resin binder, and 90% by weight of an anisotropic strontium ferrite magnetic powder (SrO.6Fe₂O₃) as a magnetic powder. These were mixed, melted and kneaded and molded into pellets. The pellet was melted to a melted state. The same manner as in the Example 1 was performed except that the magnetic particles of the melted resin magnet were unidirectionally subjected to orientation magnetization per each of the pieces while applying a magnetic field of 240 K-A/m to 2400 K-A/m using molds (dies) of a, b of FIG. 3 and a, b of FIG. 4, and each of the pieces was extrusion molded. The results of the measurement are shown in Tables 1 to 4.

### Example 3

The same manner as in the Example 1 was performed except that, referring to a magnet material for injection molding (N1 pole), there were used 10% by weight (containing a lubricating agent, a plasticizer and stabilizer) of nylon 12 (P3012U, manufactured by Ube Industries, Ltd.) as a resin binder, and 90% by weight of an anisotropic strontium ferrite magnetic powder (SrO.6Fe₂O₃) as a magnetic powder. The results of the measurement are shown in Tables 1 to 4.

### Example 4

The same manner as in the Example 1 was performed except that, referring to a magnet material for injection molding (N1 pole), there were used 10% by weight (containing a lubricating agent and a stabilizer) of ethylene-ethyl acrylate (DPDJ-9169, manufactured by Nippon Unicar Company Limited) as a resin binder, and 90% by weight of an anisotropic strontium ferrite magnetic powder (SrO.6Fe₂O₃) as a magnetic powder, and referring to a magnet material for extrusion molding (S1 pole, N2 pole, N3 pole and S2 pole), there were used 10% by weight (containing a lubricating agent and a stabilizer) of ethylene-ethyl acrylate (PES-210, manufactured by Nippon Unicar Company Limited) as a resin binder, and 90% by weight of an anisotropic strontium ferrite magnetic powder (SrO.6Fe₂O₃) as a magnetic powder. The results of the measurement are shown in Tables 1 to 4.

### Comparative Example 1

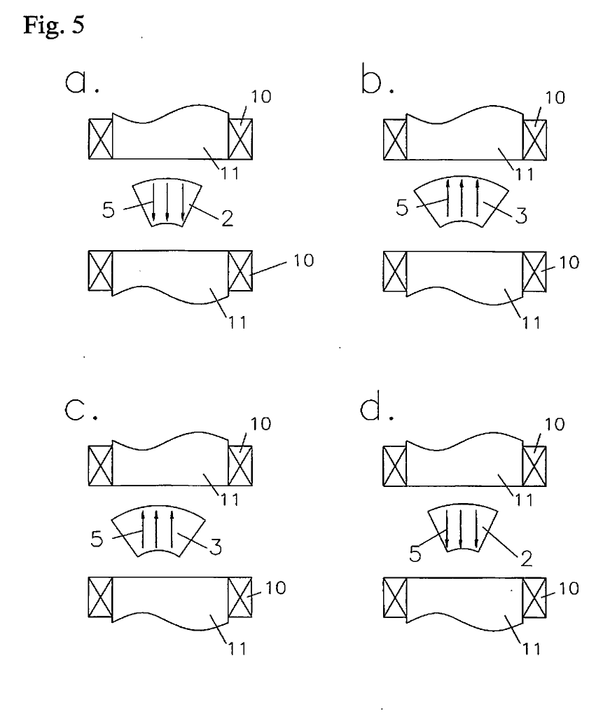

For an N1 pole, a magnet piece pole-anisotropically subjected to orientation magnetization by the completely same material and forming process as the Example 1 was formed. For poles other than the N1 pole (S1 pole, N2 pole, N3 pole and S2 pole), the same material as the N1 pole of the Example 1 was used as a magnet piece material. The magnetic particles of the melted resin magnet were unidirectionally subjected to orientation magnetization per each of the pieces while applying a magnetic field of 240 K-A/m to 2400 K-A/m using a mold having a magnetic circuit as shown in FIG. 5a, b, c, d to obtain the magnet piece by the injection molding. Therefore, the N2 pole and the N3 pole were also subjected to orientation magnetization so as to be parallel to the center line of the radial direction of the magnet piece using the mold shown in FIG. 5, and the injection molding was performed. The process and measurement after forming the magnet piece were performed in the same manner as in the Example 1. The results of the measurement are shown in Tables 1 to 4.

### Comparative Example 2

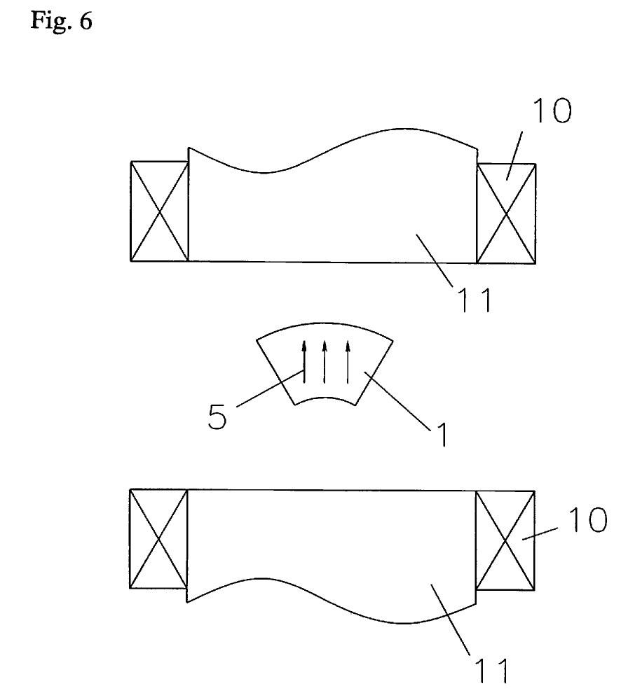

Referring to a magnet piece material for all the poles (N1 pole, S1 pole, N2 pole, N3 pole and S2 pole) of FIG. 1, there were used 10% by weight (containing a lubricating agent, a plasticizer and a stabilizer) of chlorinated polyethylene (Ebaslen 410P, manufactured by Showa Denko K.K.), and vinyl chloride-vinyl acetate copolymer (MB1008, manufactured by Kanegafuchi Chemical Ind. Co., Ltd.) as the resin binder, and 90% by weight of an anisotropic strontium ferrite magnetic powder (SrO.6Fe₂O₃) as the magnetic powder. These were mixed, melted and kneaded and molded into pellets. The pellet was melted to a melted state. The magnetic particles of the melted resin magnet were unidirectionally subjected to orientation magnetization per each of the pieces while applying a magnetic field of 240 K-A/m to 2400 K-A/m using molds (dies) having magnetic circuits of FIG. 6, a, b of FIG. 3 and a, b of FIG. 4, and the extrusion molding was performed. Particularly, the orientation magnetizing directions of the N2 pole and N3 pole are respectively inclined by 20 degrees and 25 degrees with respect to the center line of the radial direction of the magnet piece.

The process and measurement after forming the magnet piece were performed in the same manner as in the Example 1. The results of the measurement are shown in Tables 1 to 4.

As is observed from Table 1, when the Examples 1, 2, 3, 4 are compared with the Comparative Example 1, 2, the magnetic flux density patterns of the N2 pole and N3 pole of the Example 1, 2, 3, 4 are an asymmetric pattern with respect to the magnetic flux density peak. However, the magnetic flux density patterns of the N2 pole and N3 pole of the Comparative Examples 1, 2 are a symmetric pattern with respect to the magnetic flux density peak. It is turned out that the orientation magnetizing direction of the magnetic particles of the magnet pieces of the N2 pole and N3 pole of the Example 1 can be realized by inclining the magnetic particles with respect to the center line of the radial direction of the magnet piece. That is, it is turned out that an asymmetric magnetic flux density pattern with respect to the magnetic flux density peak is obtained by inclining and orientating the magnetic particles of the magnet piece like the above N2 pole and N3 pole, and a complicated magnetic flux density pattern can be formed. The asymmetric magnetic flux density pattern may enhance the carrying property of a developer, the passing performance of a developer regulation blade, the peel property of the developer or the like, and provide excellent image quality. As is observed from Table 2, when the Examples 2, 4 are compared with the Comparative Example 2, the distortion amount of the magnetic flux density peak position of each of the poles of the Examples 2, 4 is 1 degree or less. However, the distortion amount of the magnetic flux density peak position of each of the poles of the Comparative Example 2 is a maximum of 3 degrees. Since as the magnet piece material other than the N1 pole (for extrusion), the dimension accuracy of the magnet piece is enhanced by using the ethylene ethyl acrylate resin for the resin binder. As a result, the accuracy of magnetic pole position when the magnet pieces are bonded is enhanced. Also, since the dimension accuracy of an adhesion face with adjoining magnet piece and adhesion face with the shaft is enhanced, the adhesive strength is enhanced. The less distortion amount of the magnetic flux density peak position (the enhancement of the accuracy of magnetic pole position) may equalize the carrying property of the developer and provide excellent image quality.

As is observed from Table 3, when the Example 3 is compared with the Comparative Example 2, the strength the magnetic flux density of the N1 pole (development pole) of the Example 3 is 106 mT. By contrast, the strength of the magnetic flux density of the Comparative Example 2 is 95 mT. Since the magnetic particles of the magnet piece are pole-anisotropically orientated by using the polyamide resin as the resin binder, referring to the magnet piece material of the N1 pole (for injection), and as a result, the magnetic path becomes long, it is turned out that the strength of the magnetic flux density is enhanced. The fogging of the developer may be able to be decreased and prevented by the high magnetic flux density.

As is observed from Table 3, when the Example 4 is compared with the Comparative Example 1, the N1 pole of the Example 4 has the high magnetic flux density (104 mT). Also, as is observed from Table 4, each of the pieces of the Example 4 has no warpage and crack. By contrast, the N1 pole of the Comparative Example 1 has the high magnetic flux density (104 mT). However, each of the pieces has warpage of 0.18 mm to 0.23 mm, and the crack occurs on the N1 pole, the S1 pole and the N3 pole. It is turned out that the use of the ethylene ethyl alcohol resin binder for the magnet piece as in the Example 4 expresses flexibility, and has no warpage and crack. Furthermore, since the magnet piece has flexibility and excellent dimension accuracy, the adhesiveness with the shaft or adjoining magnet piece is enhanced, and the adhesive strength is enhanced. The fogging of the developer may be able to decreased and prevented by the high magnetic flux density. The crack may cause the locally rapid reduction of the magnetic flux density, and generate white line or the like on the image. The prevention of the crack may provide excellent image quality.

TABLE 1

| | N1 pole | | | | S1 pole | | | | S2 pole | | | |
|---|---|---|---|---|---|---|---|---|---|---|---|---|
| | half-length | | half-length | | half-length | | half-length | | half-length | | half-length | |
| | width of | | width of | | width of | | width of | | width of | | width of | |
| | 80% | | 50% | | 80% | | 50% | | 80% | | 50% | |
| | S2 | S1 | S2 | S1 | N1 | N2 | N1 | N2 | N3 | N1 | N3 | N1 |
| | side | side | side | side | side | side | side | side | side | side | side | side |
| Example 1 | 12 | 12 | 20 | 21 | 20 | 21 | 30 | 30 | 16 | 15 | 25 | 25 |
| Example 2 | 12 | 12 | 21 | 21 | 20 | 21 | 29 | 30 | 15 | 15 | 26 | 26 |
| Example 3 | 11 | 12 | 20 | 21 | 20 | 21 | 30 | 31 | 16 | 16 | 25 | 25 |
| Example 4 | 12 | 11 | 20 | 20 | 20 | 20 | 31 | 30 | 16 | 15 | 25 | 26 |
| Comparative | 12 | 11 | 20 | 20 | 20 | 21 | 30 | 28 | 15 | 15 | 24 | 25 |
| Example 1 | | | | | | | | | | | | |
| Comparative | 15 | 15 | 25 | 25 | 21 | 22 | 30 | 28 | 14 | 15 | 25 | 26 |
| Example 2 | | | | | | | | | | | | |

| | | | | | N3 pole | | | |
|---|---|---|---|---|---|---|---|---|
| | N2 pole | | | | | | half-length | |
| | half-length | | half-length | | half-length | | width of | |
| | width of | | width of | | width of | | 50% | |
| | 80% | | 50% | | 80% | | | S2 |
| | S1 side | N3 side | S1 side | N3 side | N2 side | S2 side | N2 side | side |
| Example 1 | 25 | 10 | 45 | 25 | 10 | 20 | 20 | 40 |
| Example 2 | 25 | 11 | 46 | 25 | 11 | 21 | 21 | 40 |
| Example 3 | 26 | 10 | 44 | 25 | 10 | 20 | 21 | 40 |
| Example 4 | 25 | 10 | 45 | 26 | 10 | 20 | 20 | 41 |
| Comparative Example 1 | 17 | 18 | 34 | 36 | 15 | 15 | 31 | 30 |
| Comparative Example 2 | 17 | 17 | 34 | 35 | 14 | 15 | 31 | 31 |

TABLE 2

| | Magnetic flux density peak position (degree) | | | | | | | | | | | | | | |
|---|---|---|---|---|---|---|---|---|---|---|---|---|---|---|---|
| | P1 point | | | | | P2 point | | | | | P3 point | | | | |
| | N1 | S1 | N2 | N3 | S2 | N1 | S1 | N2 | N3 | S2 | N1 | S1 | N2 | N3 | S2 |
| | pole | pole | pole | pole | pole | pole | pole | pole | pole | pole | pole | pole | pole | pole | pole |
| Example 1 | 0 | 60 | 150 | 230 | 310 | 0 | 61 | 149 | 228 | 310 | 0 | 61 | 151 | 231 | 311 |
| Example 2 | 0 | 60 | 150 | 230 | 310 | 0 | 60 | 151 | 231 | 310 | 0 | 60 | 150 | 231 | 310 |
| Example 3 | 0 | 60 | 149 | 229 | 310 | 0 | 59 | 150 | 230 | 310 | 0 | 60 | 152 | 231 | 311 |
| Example 4 | 0 | 60 | 150 | 230 | 310 | 0 | 60 | 150 | 231 | 310 | 0 | 60 | 151 | 230 | 310 |
| Comparative | 0 | 60 | 149 | 229 | 311 | 0 | 61 | 149 | 230 | 310 | 0 | 61 | 150 | 229 | 310 |
| Example 1 | | | | | | | | | | | | | | | |
| Comparative | 0 | 59 | 149 | 229 | 310 | 1 | 60 | 152 | 229 | 309 | 1 | 61 | 152 | 232 | 311 |
| Example 2 | | | | | | | | | | | | | | | |

| | Distortion amounts of magnetic flux density peak positions of | | | | |
|---|---|---|---|---|---|
| | P1 point to P3 point (degree) | | | | |
| | N1 pole | S1 pole | N2 pole | N3 pole | S2 pole |
| Example 1 | 0 | 1 | 2 | 3 | 1 |
| Example 2 | 0 | 1 | 1 | 1 | 0 |
| Example 3 | 0 | 1 | 3 | 2 | 1 |
| Example 4 | 0 | 0 | 1 | 1 | 0 |
| Comparative | 0 | 1 | 1 | 1 | 1 |
| Example 1 | | | | | |
| Comparative | 1 | 2 | 3 | 3 | 2 |
| Example 2 | | | | | |

TABLE 3

| | Magnetic flux density peak value of |
|---|---|
| | N1 pole (mT) |
| Example 1 | 105 |
| Example 2 | 105 |
| Example 3 | 106 |
| Example 4 | 104 |
| Comparative Example 1 | 104 |
| Comparative Example 2 | 95 |

TABLE 4

| | N1 pole | | | | | | | | | |
|---|---|---|---|---|---|---|---|---|---|---|
| | Warpage | | S1 pole | | N2 pole | | N3 pole | | S2 pole | |
| | (mm) | Crack | Warpage | Crack | Warpage | Crack | Warpage | Crack | Warpage | Crack |
| Example 1 | 0.23 | one | 0 | none | 0 | none | 0 | none | 0 | none |
| | | place | | | | | | | | |
| Example 2 | 0.18 | one | 0 | none | 0 | none | 0 | none | 0 | none |
| | | place | | | | | | | | |
| Example 3 | 0.17 | none | 0 | none | 0 | none | 0 | none | 0 | none |
| Example 4 | 0 | none | 0 | none | 0 | none | 0 | none | 0 | none |
| Comparative | 0.21 | two | 0.18 | one | 0.22 | none | 0.23 | one | 0.18 | none |
| Example 1 | | places | | place | | | | place | | |
| Comparative | 0 | none | 0 | none | 0 | none | 0 | none | 0 | none |
| Example 2 | | | | | | | | | | |

1. A magnet roller comprising:
at least one magnet piece formed by injection molding while performing pole-anisotropic orientation of magnetic particles; and
at least one magnet piece formed by extrusion molding while orientating magnetic particles in a direction inclined by 5 degrees or more and 90 degrees or less with respect to a center line of a radial direction.

2. The magnet roller according to claim 1, wherein a binder resin for the magnet piece formed by the extrusion molding is an ethylene ethyl acrylate resin.

3. The magnet roller according to claim 1, wherein a binder resin for the magnet piece formed by the injection molding is a polyamide resin.

4. The magnet roller according to claim 1, wherein a binder resin for the magnet piece formed by the injection molding is an ethylene ethyl acrylate resin.
